(19) United States
(12) Patent Application Publication
(10) Pub. No.: US 2009/0096676 A1
(43) Pub. Date: Apr. 16, 2009

(54) DURABLE WIDEBAND ANTENNA FABRICATED ON LOW RESISTIVITY SILICON SUBSTRATE

(75) Inventors: Jie Bang Yan, Hong Kong (CN); Ross David Murch, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/873,168

(22) Filed: Oct. 16, 2007

(51) Int. Cl. H01Q 1/38; G03C 5/00

(52) U.S. Cl. 343/700 MS; 430/323

(57) ABSTRACT

An antenna that is easily fabricated on a low resistivity CMOS-grade silicon substrate is herein described. The antenna has a reasonable radiation efficiency. One generalized non-limiting embodiment includes employing an antenna that resonates at about 5.8 GHz. Another generalized non-limiting embodiment includes a differential feed operationally coupled to a first and a second half-antenna portion. Each of the herein described antennas have an efficiency of greater than approximately 20%.

### TECHNICAL FIELD

The subject disclosure relates generally to wireless communication systems. The subject disclosure is particularly related to wireless communication systems that employ micro machined antennas.

### BACKGROUND

Complementary metal-oxide-semiconductor (CMOS) is a large class of integrated circuits including antennas. CMOS technology is used in chips such as microprocessors, microcontrollers, static RAM, and other digital logic circuits. CMOS technology is also used for a wide variety of analog circuits such as image sensors, data converters, and highly integrated transceivers for many types of communication. CMOS is also sometimes explained as complementary-symmetry metal-oxide-semiconductor. The words “complementary-symmetry” refer to the fact that the typical digital design style with CMOS uses complementary and symmetrical pairs of p-type and n-type metal-oxide-semiconductor field-effect transistors (MOSFETs) for logic functions. Some CMOS structures are relatively low resistivity (e.g., 5 Ωcm) CMOS grade silicon substrates which is relatively inexpensive.

One hurdle for incorporating antennas on relatively low resistivity CMOS-grade silicon substrates is to maintain a reasonable radiation efficiency. An antenna is a device that can radiate or receive electromagnetic energy. An ideal transmitting antenna accepts power from a source (perhaps a power amplifier) and radiates the power into space. That is, electromagnetic energy escapes from the antenna and, unless reflected or scattered, does not return. This is in contrast to a non-radiating electric or magnetic field generator, such as a Helmholtz coil, which generates primarily non-radiating fields. Such a device accepts energy from the source and then either returns it to the source (on alternate half cycles) or dissipates it in a resistive load. A practical antenna generates both radiating and non-radiating field components. In the Electromagnetic Compatibility (EMC) area, quasi-static field generators are usually lumped together with true antennas. Moreover, in EMC testing, antennas are often used in configurations that (intentionally or otherwise) make use of both their radiating and their non-radiating field components. If an antenna is taken as a device which accepts power from a source and radiates it into space, the ratio of the power radiated into space to the power accepted from the source is the efficiency (P_{radiated}=Pᵢₙₚᵤₜ*η_{efficiency}) sometimes termed the radiation efficiency. Radiation efficiency is defined as “the ratio of the total power radiated by an antenna to the net power accepted by the antenna from the connected transmitter” (P_{radiated}/Pᵢₙₚᵤₜ=η_{efficiency}). Thus, antenna efficiency is no different than the definition of efficiency for essentially any power conversion device.

There are several techniques that have been developed to overcome the efficiency issue, such as micro machining, thickening the isolation layer, loading a dielectric superstrate, and dielectric lens. Of these methods, micro machining is the most effective in minimizing the substrate loss. Micro machining involves the removal of lossy silicon substrate underneath the antenna structure thereby increasing the overall radiation efficiency. However, one drawback of existing micro machined antennas is their resultant frail structures. This is because the antennas are fabricated on a very thin (thickness ˜1-10 um) layer of dielectric suspended in air. Hence, the membrane can easily be damaged making wafer dicing and probe based measurement difficult. In addition, current micro machined antenna designs all have their feeding pads directly fabricated on the silicon substrate. As the silicon substrate has a low resistivity, this is equivalent to shorting the feeding pads together, which results in low radiation efficiency.

It is desirable to both provide an antenna easily fabricated on relatively low resistivity CMOS-grade silicon substrate and that has a reasonable radiation efficiency.

### SUMMARY

The generalized non-limiting embodiments described herein include an antenna easily fabricated on a low resistivity CMOS-grade silicon substrate that has a reasonable radiation efficiency. One generalized non-limiting embodiment includes employing an antenna that resonates at about 5.8 GHz. Another generalized non-limiting embodiment includes a differential feed operationally coupled to a first and a second half-antenna portion. Each of the herein described antennas has an efficiency of greater than approximately 20%. In one generalized non-limiting embodiment, the antenna is fabricated on relatively low resistivity CMOS-grade silicon substrate. In one such exemplary non-limiting embodiment, two antenna halves and a photoresist form an antenna approximately 400 um in thickness. In another embodiment, a first half-antenna portion is provided, a second half-antenna portion is separated from the first half-antenna portion, and a photoresist material connects the first and second half-antenna portions. In other embodiments, however, the scope of the claimed subject matter is not limited in this respect.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the innovation in a simplified form as a prelude to the more detailed description that follows.

### BRIEF DESCRIPTION OF THE DRAWINGS

The antennas and methods therefore in accordance with various innovations are further described with reference to the accompanying drawings in which:

FIG. 1 illustrates an antenna including a first half-antenna portion and a second half-antenna portion in accordance with the innovation;

FIG. 2a illustrates a mirrored dual portion antenna in accordance with the innovation;

FIG. 2b illustrates a mirrored dual portion antenna in accordance with the innovation;

FIG. 2c illustrates a mirrored dual portion antenna in accordance with the innovation;

FIG. 3 illustrates a bend in a mirrored dual portion antenna in accordance with the innovation;

FIG. 4 illustrates the measured S-parameters of the antenna of FIGS. 2a-2c in accordance with the innovation;

FIG. 5 illustrates the measured radiation patterns of the antenna of FIGS. 2a-2c in accordance with the innovation;

FIG. 6 illustrates a method in accordance with the innovation;

FIG. 7 illustrates a method in accordance with the innovation;

FIG. 8 illustrates a communication environment wherein a mirrored dual portion antenna is in wireless communication with a device in accordance with the innovation;

FIG. 9 illustrates a communication environment wherein a mirrored dual portion antenna is in wireless communication with a device in accordance with the innovation;

FIG. 10 is a block diagram representing an exemplary non-limiting computing system or operating environment in which the present innovation can be implemented; and

FIG. 11 illustrates an overview of a network environment suitable for service by embodiments of the innovation.

### DETAILED DESCRIPTION

### Overview

As discussed in the background, the exemplary generalized non-limiting embodiments described herein include an antenna easily fabricated on relatively low resistivity CMOS-grade silicon substrate and that has a reasonable radiation efficiency. One generalized non-limiting embodiment includes employing an antenna that resonates at about 5.8 GHz. Another generalized non-limiting embodiment includes a differential feed operationally coupled to a first and a second half-antenna portion. Each of the herein described antennas have an efficiency of greater than approximately 20%. In one generalized non-limiting embodiment, the antennas are fabricated on relatively low resistivity CMOS-grade silicon substrates and have an efficiency of greater than approximately 20%. In one such exemplary non-limiting embodiment, two antenna halves and a photoresist form an antenna approximately 400 um in thickness and is 12 mm long×2.8 mm wide. In another embodiment, a first half-antenna portion is provided, a second half-antenna portion is separated from the first half-antenna portion, and a photoresist material connects the first and second half-antenna portions.

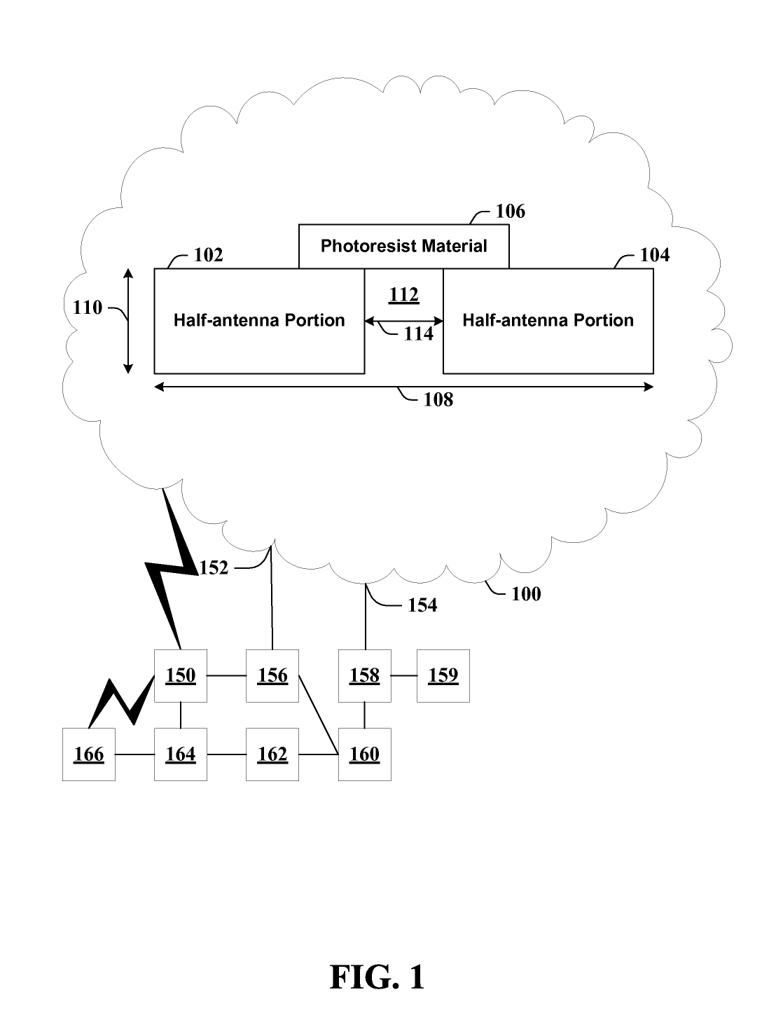

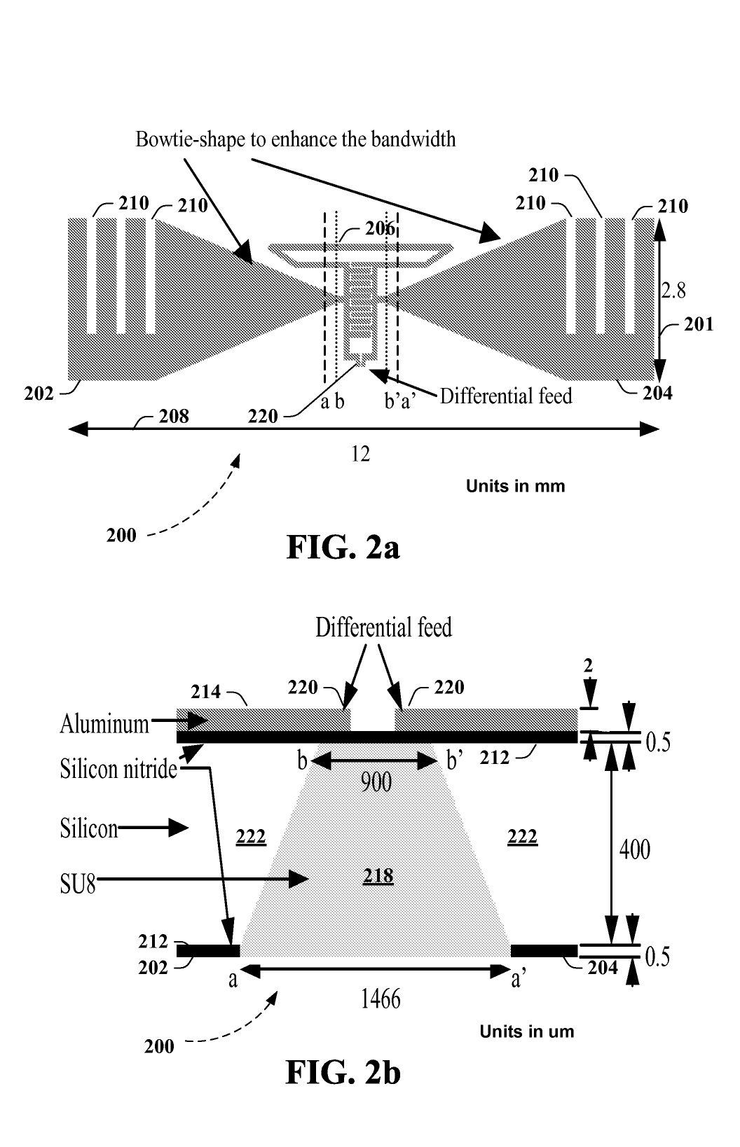

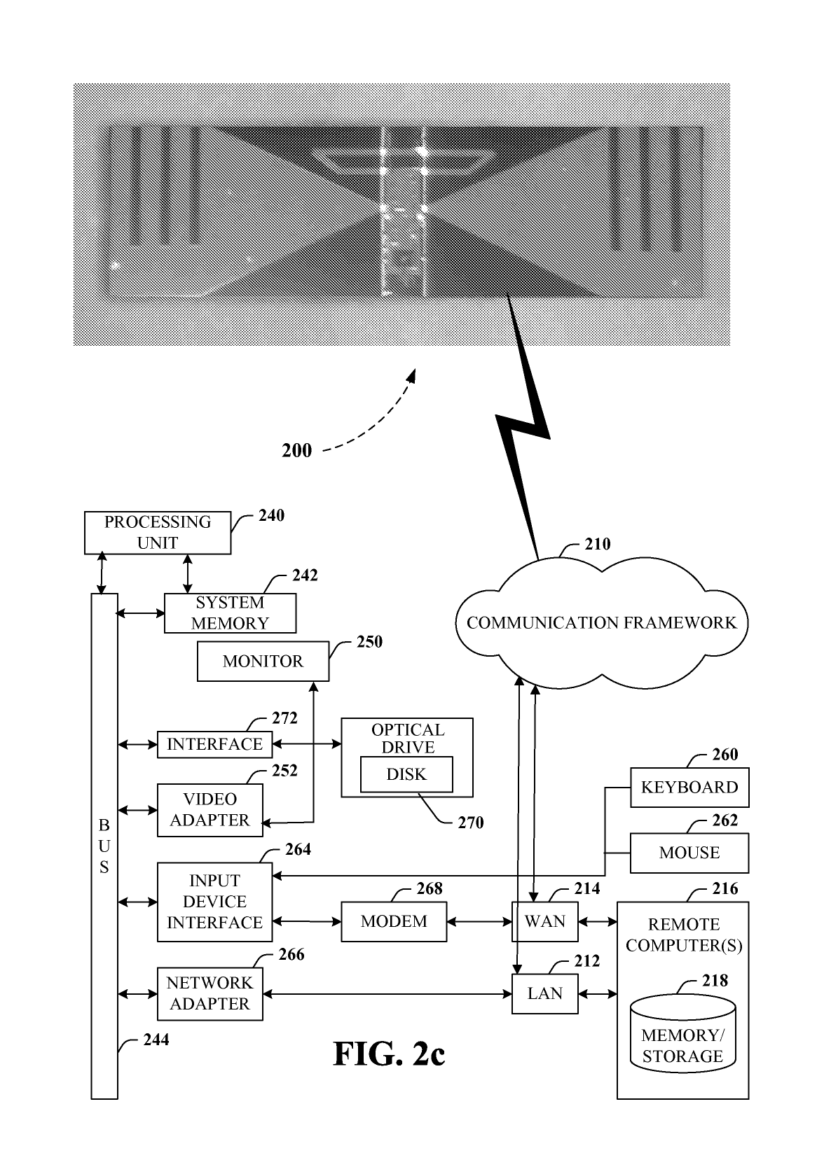

As shown in FIG. 1, an antenna 100 includes a first half-antenna portion 102 and a second half-antenna portion 104. A photo resist material 106 couples or connects the half-antenna portions 102 and 104. The antenna 100 can be fabricated on a silicon substrate with a thickness 400 um at 110 in one exemplary generalized non-limiting embodiment as shown in FIG. 1. The thickness can be between 300 um and 500 um in another exemplary generalized non-limiting embodiment and between 200 um and 700 um in still another exemplary generalized non-limiting embodiment. The silicon substrate can be a CMOS-grade (dielectric constant ∈ᵣ=11.9, resistivity=5 Ωcm) silicon substrate as best illustrated in FIG. 2b. The dimension of one exemplary generalized non-limiting antenna embodiment is 12 mm long (108)×2.8 mm wide (201 in FIG. 2a)×0.4 mm high (110) and resonates at approximately 5.8 GHz. In other embodiments the just described dimensions can be between 50% to 200% of those values. The antenna 100 can be derived from a dipole antenna in one exemplary generalized non-limiting antenna embodiment. The antenna can be a differential-fed antenna and can be easily integrated into active circuits without the need of a balun (an electronic device that converts between balanced and unbalanced electrical signals and possibly also changes impedance).

Referring back to FIG. 1, the antenna 100 can couple with a router 150 to provide antenna functionality to the router 150, for example where the router is a wireless router 150. For example, the router 150 can include at least one antenna 100. The antenna 100 can include a first lead 152 and a second lead 154 to couple to a radio-frequency (RF) transceiver 156 and/or to a radio-frequency (RF) transceiver 158. The RF transceiver 156 and/or RF transceiver 158 can couple to a processor 160, which in one or more embodiments can operate as a baseband processor to process baseband signals, for example. The processor 160 in one or more embodiments can operate as a broadband processor to process broadband signals. The processor 160 can couple to memory 162 that can store one or more instructions and/or programs, and/or data that can be utilized by processor 160. The processor 160 can couple to a network interface 164 to couple router 150 to a network 166.

Alternatively, router 150 wirelessly couples to the network 166. In one embodiment, the network 166 can include the internet or similar type of distributed network, and/or alternatively the network 166 can be any type of various network such as a local area network (LAN), wide area network (WAN), metropolitan area network (MAN), and/or the like. In one or more embodiments, the network 166 can comprise at least in part a wired network, and/or at least in part a wireless network. In one or more embodiments, the network 166 can comprise a cellular telephone network, and/or a public switched telephone network (PSTN), and/or a plain old telephone service (POTS). However, these are merely examples of networks, and the scope of the claimed subject matter is not limited in these respects.

In one or more embodiments, router 150 can be capable of utilizing antenna 100 to communicate using one or more wireless transmission standards. For example, at least one of RF transceiver 156 and/or wireless transceiver 158 and/or a third RF transceiver 159 can be part of router 150 which can be arranged to communicate using a wireless local area network transmission standard, such as in accordance with an IEEE 802.11a standard, an IEEE 802.11b standard, an IEEE 802.11g standard, and/or an IEEE 802.11n standard

It should be noted that certain generalized non-limiting exemplary embodiments can be used in a variety of applications. Although the claimed subject matter is not limited in this respect, the circuits disclosed herein can be used in many apparatuses such as in the transmitters and/or receivers of a radio system. Radio systems intended to be included within the scope of the claimed subject matter can include, by way of example, but not by way of limitation, wireless personal area networks (WPAN) such as a network in compliance with the WiMedia Alliance, a wireless local area networks (WLAN) devices and/or wireless wide area network (WWAN) devices including wireless network interface devices and/or network interface cards (NICs), base stations, access points (APs), gateways, bridges, nanocells, hubs, cellular radiotelephone communication systems, satellite communication systems, two-way radio communication systems, one-way pagers, two-way pagers, personal communication systems (PCS), personal computers (PCs), personal digital assistants (PDAs), and/or the like, although the scope of the claimed subject matter is not limited in this respect.

Types of wireless communication systems intended to be within the scope of the claimed subject matter can include, although are not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wideband CDMA (WCDMA), CDMA-2000, and/or the like, although the scope of the claimed subject matter is not limited in this respect.

In one or more embodiments, the router 150 can operate using multiple-input, multiple output (MIMO) type communication. In one particular embodiment, the router 150 can operate in accordance with an IEEE 802.11n standard. In a MIMO type embodiment, the router 150 can utilize one of antenna 100 for MIMO type and/or smart antenna type communication, for example where RF transceiver 156 and RF transceiver 158 are arranged to operate in a MIMO type mode. In one particular embodiment, router 150 can be a MIMO Wireless Router, although the scope of the claimed subject matter is not limited in this respect.

In an one exemplary generalized non-limiting antenna embodiment, the router 150 can implement a spatial division multiple access (SDMA) system, smart antenna system, and/or a multiple input, multiple output (MIMO) system, although the scope of the claimed subject matter is not limited in this respect. The router 150 can couple with the network 166 so that a remote device can communicate with the network 166, including devices coupled to network 166, by communicating with the router 150 via a wireless communication link and antenna 100. The network 166 can include a public network such as a telephone network and/or the internet, and/or alternatively the network 112 can include a private network such as an intranet, and/or a combination of a public and/or a private network, although the scope of the claimed subject matter is not limited in this respect.

The processor 160 can operate to provide baseband and/or media access control (MAC) processing functions. The processor 160 can comprise a single processor, and/or alternatively can comprise a baseband processor and/or an applications processor, although the scope of the claimed subject matter is not limited in this respect. The processor 160 can couple to memory 162 which can comprise volatile memory such as DRAM, non-volatile memory such as flash memory, and/or alternatively can include other types of storage such as a hard disk drive, although the scope of the claimed subject matter is not limited in this respect. Some portion or all of memory 162 can be included on the same integrated circuit as processor 160, and/or alternatively some portion and/or all of memory 162 can be disposed on an integrated circuit and/or other medium, for example a hard disk drive, that is external to the integrated circuit of processor 160, although the scope of the claimed subject matter is not limited in this respect.

Communication between the router 150 to a remote device can be implemented via a wireless personal area networks (WPAN) such as in compliance with the WiMedia Alliance, a wireless local area network (WLAN), for example a network compliant with a an Institute of Electrical and Electronics Engineers (IEEE) standard such as IEEE 802.11a, IEEE 802.11b, IEEE 802.11g, IEEE 802.11n, IEEE 802.16, HiperLAN-II, HiperMAN, Ultra-Wideband (UWB), and so on, although the scope of the claimed subject matter is not limited in this respect. In another embodiment, communication between router 150 and a remote device can be at least partially implemented via a cellular communication network compliant with a Third Generation Partnership Project (3GPP or 3G) standard, a Wideband CDMA (WCDMA) standard, and/or other types of cellular networks, although the scope of the claimed subject matter is not limited in this respect.

Since the antenna 100 can be fabricated on a low resistivity silicon substrate, the scenario is similar to placing a dipole antenna in very close proximity (<<λ₀/4) to a conductor (where λ₀ is the wavelength of the radiated EMF). Although the conductor in one herein described embodiment is a poor conductor (resistivity=5 Ωcm), the conductor would still short both sides of the radiating arm of the dipole antenna, resulting in very low radiation efficiency. Therefore, to achieve an acceptable radiation efficiency, herein described is the division of the conductive silicon substrate into two halves and the central portion is replaced by an insulating material such as for example but not limited to SU-8 (dielectric constant ∈ᵣ=4.1) as best illustrated in FIGS. 2a and 2b.

In one exemplary generalized non-limiting embodiment, a full slot is open in the middle part of the lossy silicon substrate such that the differential RF signal flowing along the antenna's arms can no longer be shorted by the conductive substrate. For example, in FIG. 1 a slot 112 separates the half-antenna portions 102 and 104. The slot 112 can be from about 900 um to 1466 um at 114, in one exemplary generalized non-limiting antenna embodiment. In other exemplary generalized non-limiting antenna embodiments, the slot 112 can be from about 700 um to 1700 um at 114. In another exemplary generalized non-limiting antenna embodiment, the slot 112 can be from about 400 um to 2000 um at 114. The photoresist SU-8 acts not only as an efficient isolation block, but the photoresist SU-8 also provides a very strong mechanical support to the thin silicon nitride membrane. Hence, even though the feeding pads are located on the membrane, it can be probed without breaking the antenna into the two halves 102 and 104. SU-8 is a commonly used negative photoresist. SU-8 is a very viscous polymer that can be spun or spread over a thickness ranging from 1 micrometer up to 2 millimeters and still be processed with a standard mask aligner. SU-8 can be used to pattern high aspect ratio (>20) structures. SU-8's maximum absorption is for ultraviolet light with a wavelength of 365 nm. When exposed, SU-8's long molecular chains cross-link causing the solidification of the material. SU-8 is mainly used in for fabrication of microfluidics and MEMS parts. SU-8 is also one of the most bio-compatible materials and is often used in bio-MEMS. As used herein silicon is lossy if it is such that any signal line operating beyond 1 GHz becomes a transmission line.

Another factor typically considered in antenna design is the size, especially for antenna fabricated on silicon. To facilitate minimizing the size of the antenna, reactive loadings are added next to the feed 220 of the antenna, as shown in FIGS. 2a and 2b. Apart from this feed, three slits 210 can be added at the ends of the antenna to lengthen the current path and thereby reducing the overall resonant length to 0.46λ₀. A 0.5 um thin silicon nitride layer 212 can be inserted in between the differential feed 220 and a silicon substrate 222 that act as an insulating membrane in one exemplary generalized non-limiting antenna embodiment. To achieve a wide bandwidth for Ultra Wideband (UWB) applications, a bowtie shape can be incorporated into the geometry of the antenna as indicated in FIG. 2a. Ultra Wideband was traditionally accepted as pulse radio, but now UWB is typically defined in terms of a transmission from an antenna for which the emitted signal bandwidth exceeds the lesser of 500 MHz or 20% of the center frequency. Thus, pulse-based systems—wherein each transmitted pulse instantaneously occupies the UWB bandwidth, or an aggregation of at least 500 MHz worth of narrow band carriers, for example in orthogonal frequency-division multiplexing (OFDM) fashion—can gain access to the UWB spectrum under the rules.

Pulse repetition rates may be either low or very high. Pulse-based radars and imaging systems tend to use low repetition rates, typically in the range of 1 to 100 megapulses per second. On the other hand, communications systems favor high repetition rates, typically in the range of 1 to 2 giga-pulses per second, thus enabling short-range gigabit-per-second communications systems. Each pulse in a pulse-based UWB system occupies the entire UWB bandwidth, thus reaping the benefits of relative immunity to multipath fading (but not to intersymbol interference), unlike carrier-based systems that are subject to both deep fades and intersymbol interference.

The power spectral density emission limit for UWB emitters operating in the UWB band is −41.3 dBm/MHz. This is the same limit that applies to unintentional emitters in the UWB band, the so called Part 15 limit. However, the emission limit for UWB emitters can be significantly lower (as low as −75 dBm/MHz) in other segments of the spectrum.

A significant difference between traditional radio transmissions and UWB radio transmissions is that traditional transmissions transmit information by varying the power/frequency/and or phase of a sinusoidal wave. UWB transmissions can transmit information by generating radio energy at specific time instants and occupying large bandwidth thus enabling a pulse-position or time-modulation. But also information can be imparted (modulated) on UWB signals (pulses) by encoding the polarity of the pulse, the amplitude of the pulse, and/or also by using orthogonal pulses. UWB pulses can be sent sporadically at relatively low pulse rates to support time/position modulation, but can also be sent at rates up to the inverse of the UWB pulse bandwidth. Pulse-UWB systems have been demonstrated at channel pulse rates in excess of 1.3 giga-pulses per second using a continuous stream of UWB pulses (Continuous Pulse UWB or “C-UWB”), supporting forward error correction encoded data rates in excess of 675 Mbit/s. Such a pulse-based UWB method using bursts of pulses is the basis of the IEEE 802.15.4a draft standard and working group, which has herein described UWB as an alternative PHY layer.

FIGS. 2a and 2b illustrate an antenna 200 with a first half-antenna portion 202 and a second half-antenna portion 204. A photo resist material 206 couples or connects the half-antenna portions 202 and 204. The antenna 200 can be fabricated on a silicon substrate with a thickness 400 um as shown in FIG. 2b. The thickness can be between 300 um and 500 um in another exemplary generalized non-limiting embodiment and between 200 um and 700 um in still another exemplary generalized non-limiting embodiment. The silicon substrate can be a CMOS-grade (∈ᵣ=11.9, resistivity=5 Ωcm) silicon substrate as best illustrated in FIG. 2b. The dimension of one exemplary generalized non-limiting antenna embodiment is 12 mm long×2.8 mm wide×0.4 mm high and resonates at approximately 5.8 GHz. In other embodiments, the just described dimensions can be between 50% to 200% of those values. A 0.5 um thin silicon nitride layer 212 can be inserted in between the feed 220 and a silicon substrate 222 that act as an insulating membrane in one exemplary generalized non-limiting antenna embodiment illustrated in FIG. 2b. The length of a slot 210 is 0.148λ which is equal to 18.5 mm in one exemplary generalized non-limiting embodiment. Although the herein described dimensions are provided, there is inherent leeway in the dimensions and therefore as used herein “about” means within 20% plus or minus, “in close tolerance to” means within 10% plus or minus, and “in tight tolerance to” means within 5% plus or minus, and for every numerical limitation or description disclosed herein these variances may be applied unless otherwise explicitly noted.

The antenna design was simulated using a commercially available finite element based electromagnetic simulator. From the simulation results, the herein described antenna has a gain of −2.19 dB and radiates with a 20.5% efficiency, which is relatively high for such a small silicon antenna. The simulated bandwidth of the antenna is 49%. If the central portion of the silicon substrate is not etched away, the radiation efficiency would then be 0.91% only. Indeed, if no antenna minimization technique is applied to the antenna (which is then a typical dipole antenna as seen in FIG. 1), the radiation efficiency of the antenna could reach 96.7% according to the simulation result. Therefore, it can be deduced that the loss in one of the herein described antenna structure is mainly due to the addition of reactive loadings and slits for antenna minimization, and does not come from the lossy silicon substrate. Thus, there is a tradeoff between the antenna size and its radiation efficiency as would be expected. At high frequency ranges, where the size of the antenna is no longer an issue, the herein described micro machining technique can be applied to fabricate highly efficient on-chip antennas.

An antenna as herein described was fabricated in the Nanoelectronics Fabrication Facility at the Hong Kong University of Science and Technology. Prior to fabrication, the resistivity of the silicon substrate was measured by a four point probe and was found to be 4.71 Wcm, which is slightly different from the simulated value. A 0.5 um thin low-stress silicon nitride was then deposited on both sides of the silicon wafer by a chemical vapor deposition (CVD) process. A 2 um thick layer of pure aluminum was sputtered on the front side of the substrate. The aluminum layer was then patterned into the antenna geometry described in the previous section by photolithography. On the back side of the wafer, windows were opened on the nitride layer for selective silicon etching. Before etching, the front side of the wafer was coated with a 4 um thick photoresist for protecting the aluminum layer. The wafer was also enclosed in an O ring before putting into the etching bath for further protection. The silicon substrate was then completely etched through the backside by a Tetra-Methyl-Ammonium Hydroxide (TMAH) solution with nitride being the mask. The advantage of using TMAH over Potassium Hydroxide (KOH) is that TMAH is CMOS-compatible. After silicon etching, a negative photoresist, SU-8, was coated on the backside of the wafer and therefore filling the empty cavities as shown in FIG. 2a. The wafer was then soft-baked to remove moisture before the ultra-violet (UV) illumination on the backside. After the SU-8 was hardened by UV light, a post exposure bake was performed. The front side was then exposed to UV radiation to ensure that the SU-8 near the membrane is hardened.

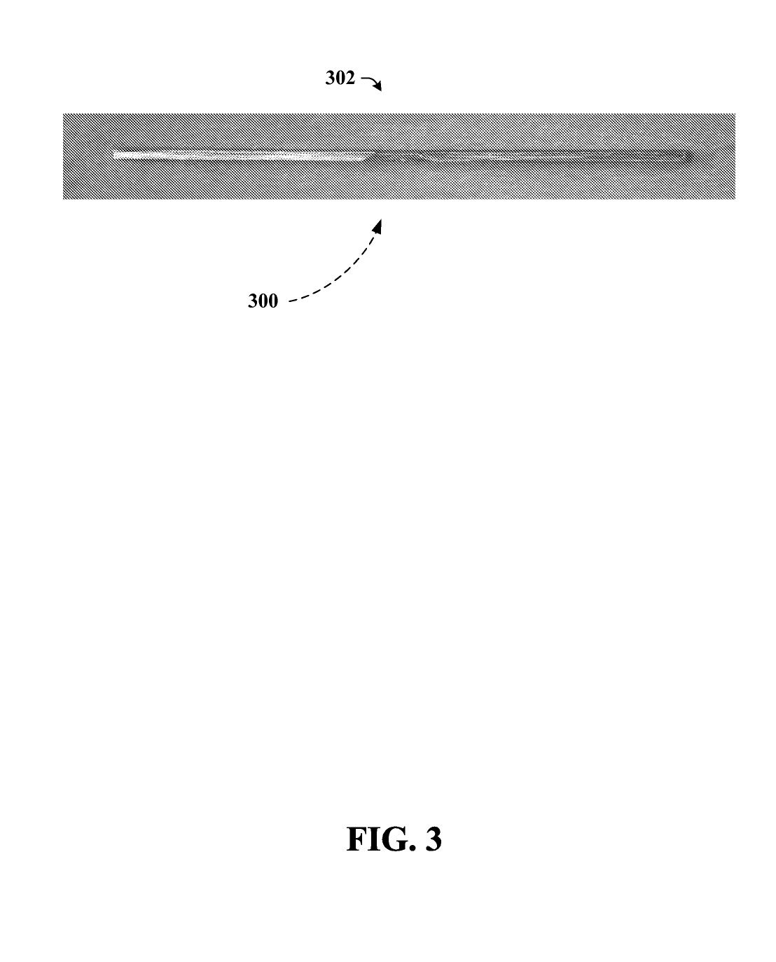

Another post exposure bake followed. The fabricated antenna is shown in FIG. 2c. From FIG. 3, it can be seen at 302 that the silicon etching leaves a slant edge on antenna 300. This is because TMAH is an anisotropic material and the silicon wafer is oriented <100> (this is a vector indicating the crystal orientation). Individual antennas were then diced out from the wafer for measurement.

### Experimental Results

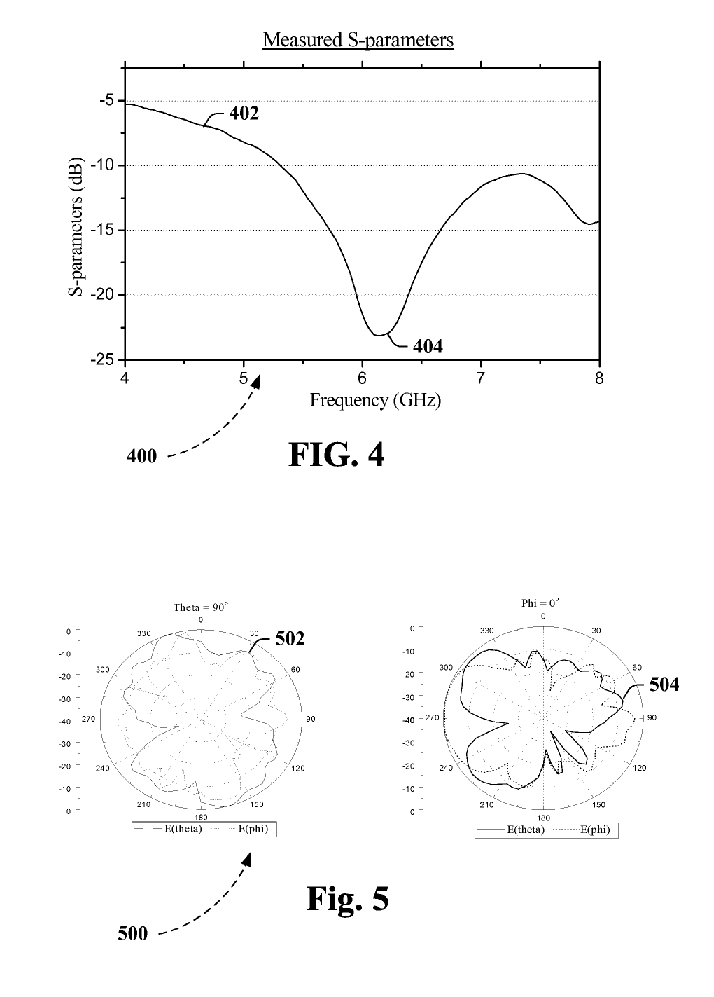

The S-parameters of the fabricated antenna were measured experimentally a probe station and a probe, together with a four-port network analyzer (0.3 GHz-8 GHz). A differential one-port calibration up to the probe tip was carried out using the open, short, load on the standard calibration substrate. The measured S-parameters are shown in FIG. 4 on a graph 400 with a curve 402 illustrating the S-parameters (dB) with a low portion at 404. As observed from the graph 400, the fabricated antenna has a bandwidth of more than 43%. During the measurement, the antenna structure remained intact even when the microwave probe was pressed against onto the feed which resides on the membrane demonstrating the strength of the structure. The radiation patterns of the fabricated antenna were also measured and are given in a graph 500 on FIG. 5. Theta is graphed at 502 and phi is graphed at 504. The radiation patterns basically resemble that of a typical dipole antenna. The radiation efficiency and the gain of the antenna were measured using an antenna measurement system and are found to be 22% and −1.35 dB which agree very well with the simulation results.

In some of the herein described exemplary embodiments, the membrane of the antenna is supported by a rigid photoresist that previous designs do not have. This support structure not only can provide a strong mechanical support, but also can increase the testability of the fabricated antenna. Moreover, some of the herein described exemplary embodiments have a much thinner isolation membrane as compared to existing designs. This is beneficial for integrating the antenna with active circuits since the thin membrane could avoid a high aspect ratio interlayer connection that is generally undesirable in integrated circuit fabrication. Secondly, one may note that some of the herein described exemplary embodiments have a relatively low gain. This is due to the fact that the size of some of the herein described exemplary antenna embodiments is much smaller than previous designs. However, for antennas fabricated on silicon substrate, planar size is a key issue and hence, there is a need to sacrifice the antenna gain for the chip area. It should also be pointed out that the silicon substrates used in previous designs have resistivities of up to three times higher than the herein described design. This would also explain their relatively high gains and radiation efficiencies.

A novel micro machining technique is applied to open a full slot in the silicon substrate for the fabrication of a strong wideband antenna. By replacing the etched full slot underneath the feed with a non-conductive material SU-8, the unwanted substrate loss is greatly reduced. Also, the membrane suspending the antenna structure is strongly supported by the SU-8. The resultant antenna therefore becomes much more reliable. Experimental results show that the fabricated antenna resonates at the 5.8 GHz ISM band and has an impedance bandwidth exceeding 43%. The industrial, scientific, and medical (ISM) radio bands were originally reserved internationally for the use of RF electromagnetic fields for industrial, scientific, and medical purposes other than communications. In general, communications equipment must accept any interference generated by ISM equipment. The ISM bands are defined by the Radio communications Bureau of the International Telecommunication Union (ITU-R) in 5.138, 5.150, and 5.280 of the Radio Regulations. A radiation efficiency of 22.1% and a gain of −1.35 dB are also measured. The results indicate that the herein described antenna is suitable for air-transmission purposes and can be used in IEEE 802.11a and UWB applications.

As shown in FIG. 2c, the antenna 200 can communicate as described below. The antenna 200 includes a coaxial feed point in which a coaxial or other type of cable can be attached in order to transmit or receive from or to a communication framework 210. Alternatively or in addition to the cable feed point, the antenna 200 can be in wireless communication with the framework. For example, antenna 200 can couple with a LAN or WAN along with a plurality of remote computers 216 having associated memory storage 218. The exemplary environment 210 for implementing various aspects of the innovation includes a computer-processing unit 240, a system memory 242, and a system bus 244. The system bus 244 couples system components including, but not limited to, the system memory 242 to the processing unit 240. The processing unit 240 can be any of various commercially available processors. Dual microprocessors and other multi processor architectures can also be employed as the processing unit 240.

The system bus 244 can be any of several types of bus structure that can further interconnect to a memory bus (with or without a memory controller), a peripheral bus, and a local bus using any of a variety of commercially available bus architectures. The system memory 242 includes read-only memory (ROM) and random access memory (RAM). A basic input/output system (BIOS) is stored in a generalized non-volatile memory such as ROM, EPROM, EEPROM, which BIOS contains the basic routines that help to transfer information between elements within the computer 240, such as during start-up. The RAM can also include a high-speed RAM such as static RAM for caching data.

The computer processor 240 further includes an internal hard disk drive (HDD) (e.g., EIDE, SATA), which internal hard disk drive can also be configured for external use in a suitable chassis (not shown), a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive, and optical disk drive can be connected to the system bus by a hard disk drive interface, a magnetic disk drive interface, and an optical drive interface, respectively. The interface for external drive implementations includes at least one or both of Universal Serial Bus (USB) and IEEE 1394 interface technologies. Other external drive connection technologies are within contemplation of the subject innovation.

The drives and their associated computer-readable media provide non-volatile storage of data, data structures, computer-executable instructions, and so forth. For the computer 240, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the innovation.

A number of program modules can be stored in the drives and RAM, including an operating system, one or more application programs, other program modules, and program data. All or portions of the operating system, applications, modules, and/or data can also be cached in the RAM. It is appreciated that the innovation can be implemented with various commercially available operating systems or combinations of operating systems.

A user can enter commands and information into the computer 240 through one or more wired/wireless input devices, e.g., a keyboard 260 and a pointing device, such as a mouse 262. Other input devices (not shown) can include a microphone, an IR remote control, a joystick, a game pad, a stylus pen, touch screen, or the like. These and other input devices are often connected to the processing unit 240 through an input device interface 264 that is coupled to the system bus 244, but can be connected by other interfaces, such as a parallel port, an IEEE 1394 serial port, a game port, a USB port, an IR interface, etc.

A monitor 250 or other type of display device is also connected to the system bus 244 via an interface, such as a video adapter 252. In addition to the monitor 250, a computer typically includes other peripheral output devices (not shown), such as speakers, printers, etc.

The computer 240 can operate in a networked environment using logical connections via wired and/or wireless communications to one or more remote computers, such as the remote computer(s) 216. The remote computer(s) 216 can be a workstation, a server computer, a router, a personal computer, portable computer, microprocessor-based entertainment appliance, a peer device or other common network node, and typically includes many or all of the elements described relative to the computer 216, although, for purposes of brevity, only a memory/storage device 218 is illustrated. The logical connections depicted include wired/wireless connectivity to the local area network (LAN) 212 and/or larger networks, e.g., a wide area network (WAN) 214. Such LAN and WAN networking environments are commonplace in offices and companies, and facilitate enterprise-wide computer networks, such as intranets, all of which can connect to a global communications network, e.g., the Internet.

When used in a LAN networking environment, the computer 240 is connected to the local network 212 through a wired and/or wireless communication network interface or adapter 266. The adapter 266 can facilitate wired or wireless communication to the LAN 212, which can also include a wireless access point disposed thereon for communicating with the mirrored dual portion antenna 202.

When used in a WAN networking environment, the computer 240 can include a modem 268, or is connected to a communications server on the WAN 214, or has other means for establishing communications over the WAN 214, such as by way of the Internet. The modem 268, which can be internal or external and a wired or wireless device, is connected to the system bus 244 via the serial port interface 264. In a networked environment, program modules depicted relative to the computer 240, or portions thereof, can be stored in the remote memory/storage device 218. It will be appreciated that the network connections shown are exemplary and other means of establishing a communications link between the computers can be used.

The computer 240 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

In one or more embodiments, communication framework 210 can operate using multiple-input, multiple output (MIMO) type communication. In one particular embodiment, communication framework 210 can operate in accordance with an IEEE 802.11n standard.

In another embodiment, communication framework 210 can utilize additional MIMO channels with two or more antennas, at least some of which can be a dipole antenna such as antenna 202. In embodiments where multiple antennas such as antenna 202 are utilized, two MIMO channels can be utilized on for each corresponding one of antenna 202, although the scope of the claimed subject matter is not limited in this respect. In an alternative embodiment, communication framework 210 can implement a spatial division multiple access (SDMA) system, smart antenna system, and/or a multiple input, multiple output (MIMO) system, although the scope of the claimed subject matter is not limited in this respect.

Processor 240 can operate to provide baseband and/or media access control (MAC) processing functions. Processor 240 can comprise a single processor, and/or alternatively can comprise a baseband processor and/or an applications processor, although the scope of the claimed subject matter is not limited in this respect. Processor 240 can couple to memory 242 which can comprise volatile memory such as DRAM, non-volatile memory such as flash memory, and/or alternatively can include other types of storage such as a hard disk drive, although the scope of the claimed subject matter is not limited in this respect. Some portion or all of memory 242 can be included on the same integrated circuit as processor 260, and/or alternatively some portion and/or all of memory 242 can be disposed on an integrated circuit and/or other medium, for example a hard disk drive, that is external to the integrated circuit of processor 260, or the computer 260 although the scope of the claimed subject matter is not limited in this respect. An optical disk drive 270 in communication to the bus 244 via an interface 272 is provided in one embodiment to provide additional storage over other storage already provided.

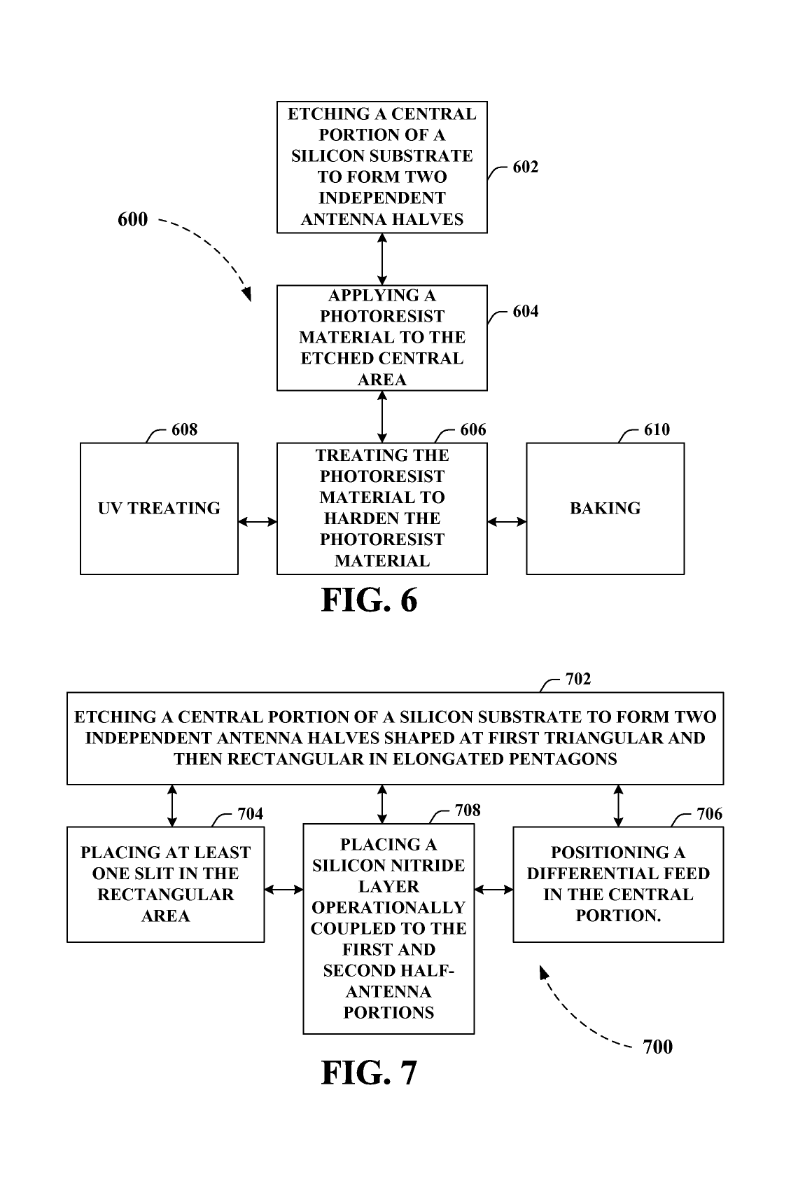

FIG. 6 illustrates a method 600 that includes in one exemplary generalized non-limiting embodiment etching a central portion of a silicon substrate to form two independent antenna halves at 602. At 604, the method 600 includes applying a photoresist material to the etched central area. Treating the photoresist material to harden the photoresist material is at 606, wherein the treating can be a UV treating at 608, and\or a baking treating at 610. A 0.5 um thin low-stress silicon nitride can be deposited on both sides of the silicon wafer by a chemical vapor deposition (CVD) process. A 2 um thick layer of pure aluminum can be sputtered on the front side of the substrate. The aluminum layer can be patterned into the antenna geometry described above by photolithography. On the back side of the wafer, windows can be opened on the nitride layer for selective silicon etching. Before etching, the front side of the wafer can be coated with a 4 um thick photoresist for protecting the aluminum layer. The wafer can be enclosed in an O ring before putting into the etching bath for further protection. The silicon substrate can be then completely etched through the backside by a Tetra-Methyl-Ammonium Hydroxide (TMAH) solution with nitride being the mask. After the silicon etching, a negative photoresist, SU-8, can be coated on the backside of the wafer and therefore filling the empty cavities as shown in FIG. 2a. The wafer was then soft-baked to remove moisture before the ultra-violet (UV) illumination on the backside. After the SU-8 was hardened by UV light, a post exposure bake was performed. The front side was then exposed to UV radiation to ensure that the SU-8 near the membrane is hardened. Another post exposure bake followed. The fabricated antenna is shown in FIG. 2c.

FIG. 7 illustrates a method 700 that includes in one exemplary generalized non-limiting embodiment etching a central portion of a silicon substrate to form two independent antenna halves shaped at first triangular and then rectangular in elongated pentagons at 702. The method 700 also includes an embodiment with at least one slit in the rectangular area at 704. Positioning a differential feed in the central portion is at 706. And placing a silicon nitride layer operationally coupled to the first and second half-antenna portions is at 708.

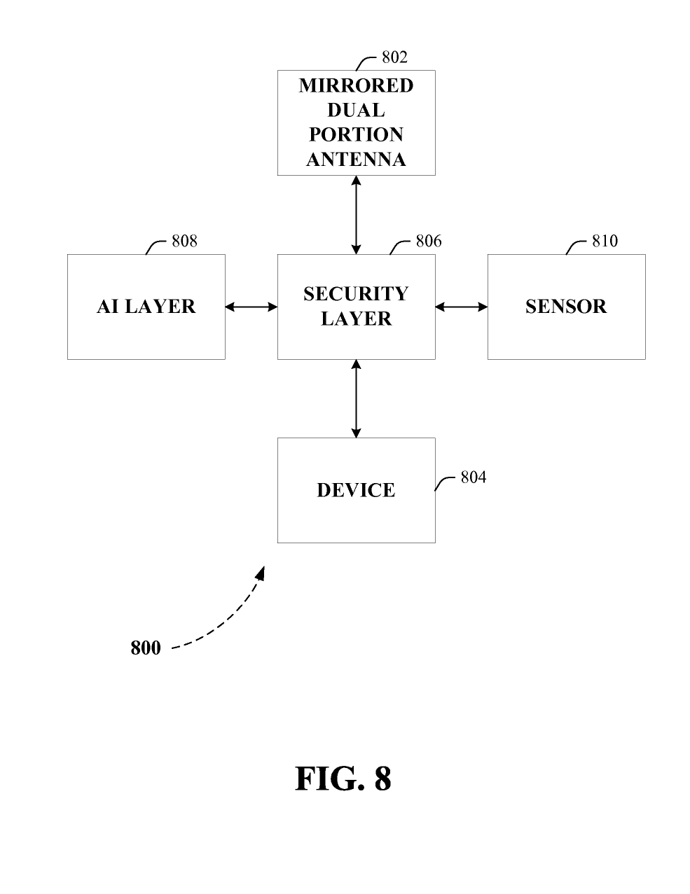

FIG. 8 illustrates a communication environment 800 wherein a mirrored dual portion antenna 802 is in wireless communication with a device 804. Device 804 can be a wireless device and antenna 802 can be in direct communication with the device 804, or the device 804 can be a wired device and the antenna 802 is in communication with the device 804 through a intermediately device (not shown), however some of the communication path involves wireless communication. The device can be any device already described herein or it can be a device not already herein described such as a user wearable device such as a wearable personal computers (or “wearables”). Wearables are devices that commonly serve as electronic companions and intelligent assistants to their users, and are typically strapped to their users' bodies or carried by their user in a holster. Like other computers, wearables can have access to a wide variety of input devices. Moreover, in addition to more conventional input devices, a wearable can have a variety of other input devices such as chording keyboards or a digitizer tablet. Similarly, a wearable computer can have access to a wide variety of sensors, such as barometric pressure sensors, global positioning system devices, or a heart rate monitor for determining the heart rate of its user. Wearables also can have access to a wide variety of generalized non-conventional output devices.

Device 804 can be virtually any electronic device where data can be stored. Examples of such electronic devices can include a computer, a cellular phone, a digital phone, a video device (e.g., video playing and/or recording device), a smart card, a personal digital assistant (PDA), a television, an electronic game (e.g., video game), a digital camera (stand alone or integrated with a cellular phone), an electronic organizer, an audio player and/or recorder, an electronic device associated with digital rights management, Personal Computer Memory Card International Association (PCMCIA) cards, trusted platform modules (TPMs), Hardware Security Modules (HSMs), set-top boxes, secure portable tokens, Universal Serial Bus (USB) tokens, key tokens, secure memory devices with computational capabilities, devices with tamper-resistant chips, and the like.

Because at least a portion of the communication between the device 804 and the mirrored dual portion antenna is wireless, a security layer 806 is provided in one exemplary generalized non-limiting embodiment. The security layer 806 can be used to cryptographically protect (e.g., encrypt) data as well as to digitally sign data, to enhance security and unwanted, unintentional, or malicious disclosure. In operation, the security component or layer 802 can communicate data to/from both the antenna 802 and the retrieval component device 804.

An encryption component can be used to cryptographically protect data during transmission as well as while stored. The encryption component employs an encryption algorithm to encode data for security purposes. The algorithm is essentially a formula that is used to turn data into a secret code. Each algorithm uses a string of bits known as a ‘key’ to perform the calculations. The larger the key (e.g., the more bits in the key), the greater the number of potential patterns can be created, thus making it harder to break the code and descramble the contents of the data.

Most encryption algorithms use the block cipher method, which code fixed blocks of input that are typically from 64 to 128 bits in length. A decryption component can be used to convert encrypted data back to its original form. In one aspect, a public key can be used to encrypt data upon transmission to a storage device. Upon retrieval, the data can be decrypted using a private key that corresponds to the public key used to encrypt.

A signature component can be used to digitally sign data and documents when transmitting and/or retrieving from the device 804. It is to be understood that a digital signature or certificate guarantees that a file has not been altered, similar to if it were carried in an electronically sealed envelope. The ‘signature’ is an encrypted digest (e.g., one-way hash function) used to confirm authenticity of data. Upon accessing the data, the recipient can decrypt the digest and also re-compute the digest from the received file or data. If the digests match, the file is proven to be intact and tamper free. In operation, digital certificates issued by a certification authority are most often used to ensure authenticity of a digital signature.

Still further, the security layer 806 can employ contextual awareness (e.g., context awareness component) to enhance security. For example, the contextual awareness component can be employed to monitor and detect criteria associated with data transmitted to and requested from the device 804. In operation, these contextual factors can be used to filter spam, control retrieval (e.g., access to highly sensitive data from a public network), or the like. It will be understood that, in aspects, the contextual awareness component can employ logic that regulates transmission and/or retrieval of data in accordance with external criteria and factors. The contextual awareness employment can be used in connection with an artificial intelligence (AI) layer 808.

The AI layer or component can be employed to facilitate inferring and/or determining when, where, how to dynamically vary the level of security. Such inference results in the construction of new events or actions from a set of observed events and/or stored event data, whether or not the events are correlated in close temporal proximity, and whether the events and data come from one or several event(s) and data source(s).

The AI component can also employ any of a variety of suitable AI-based schemes in connection with facilitating various aspects of the herein described innovation. Classification can employ a probabilistic and/or statistical-based analysis (e.g., factoring into the analysis utilities and costs) to prognose or infer an action that a user desires to be automatically performed. The AI layer can be used in conjunction with the security layer to infer changes in the data being transferred and make recommendations to the security layer as to what level of security to apply.

For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

Additionally a sensor 810 can be employed in conjunction with the security layer 806. Still further, human authentication factors can be used to enhance security employing sensor 810. For instance, biometrics (e.g., fingerprints, retinal patterns, facial recognition, DNA sequences, handwriting analysis, voice recognition) can be employed to enhance authentication to control access of the storage vault. It will be understood that embodiments can employ multiple factor tests in authenticating identity of a user.

The sensor 810 can also be used to provide the security layer 806 with generalized non-human metric data, such as electromagnetic field condition data or predicted weather data etc. For example, any conceivable condition can be sensed for and security levels can be adjusted or determined in response to the sensed condition.

One of ordinary skill in the art can appreciate that the innovation can be implemented in connection with any computer or other client or server device, which can be deployed as part of a computer network, or in a distributed computing environment, connected to any kind of data store. In this regard, the present innovation pertains to any computer system or environment having any number of memory or storage units, and any number of applications and processes occurring across any number of storage units or volumes, which can be used in connection with optimization algorithms and processes performed in accordance with the present innovation. The present innovation can apply to an environment with server computers and client computers deployed in a network environment or a distributed computing environment, having remote or local storage. The present innovation can also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices can have applications, objects or resources that can implicate the optimization algorithms and processes of at least one generalized non-limiting embodiment.

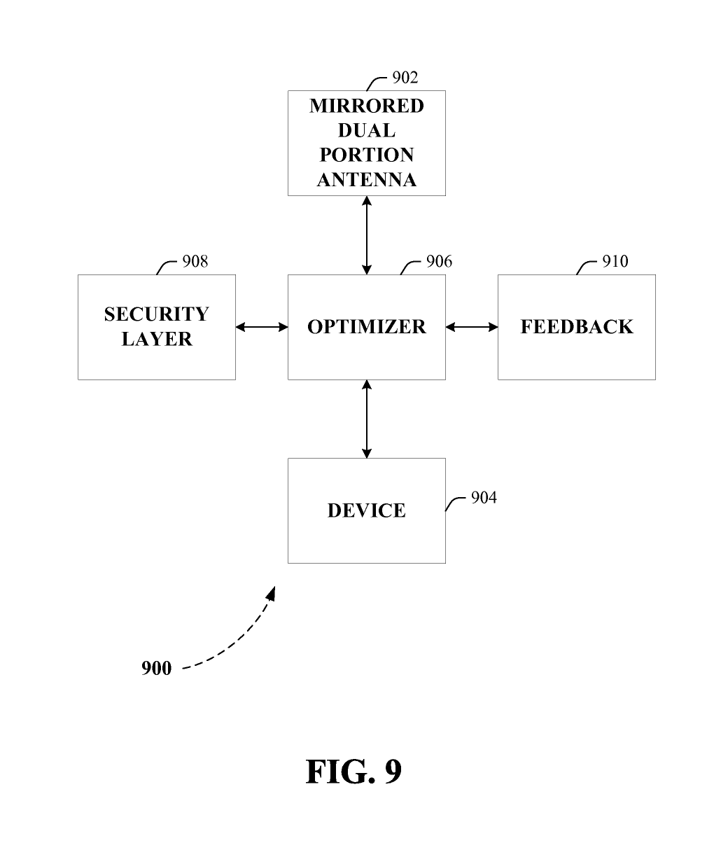

FIG. 9 illustrates a communication environment 900 wherein a mirrored dual portion antenna 902 is in wireless communication with a device 904. Device 904 can be a wireless device and antenna 902 can be in direct communication with the device 904, or the device 904 can be a wired device and the antenna 902 is in communication with the device 904 through a intermediately device (not shown), however some of the communication path involves wireless communication. An optimizer 906 is provided to optimize communication between 902 and device 904. Optimizer 906 optimizes or increases communication between 902 and device 904 by receiving security information from security layer 908. For example, when security layer 908 informs optimizer 906 that they are both in a secured environment, the optimizer 906 balances this information with other information and may instruct the security layer 908 to make all transmissions security free to achieve top speed. Additionally, a feedback layer or component 910 can provide feedback as to missed data packets or other information to provide feedback to the optimizer 906. This feedback of missed packets can be balanced against desired security level to enable less secure but higher throughput data transfer if desired.

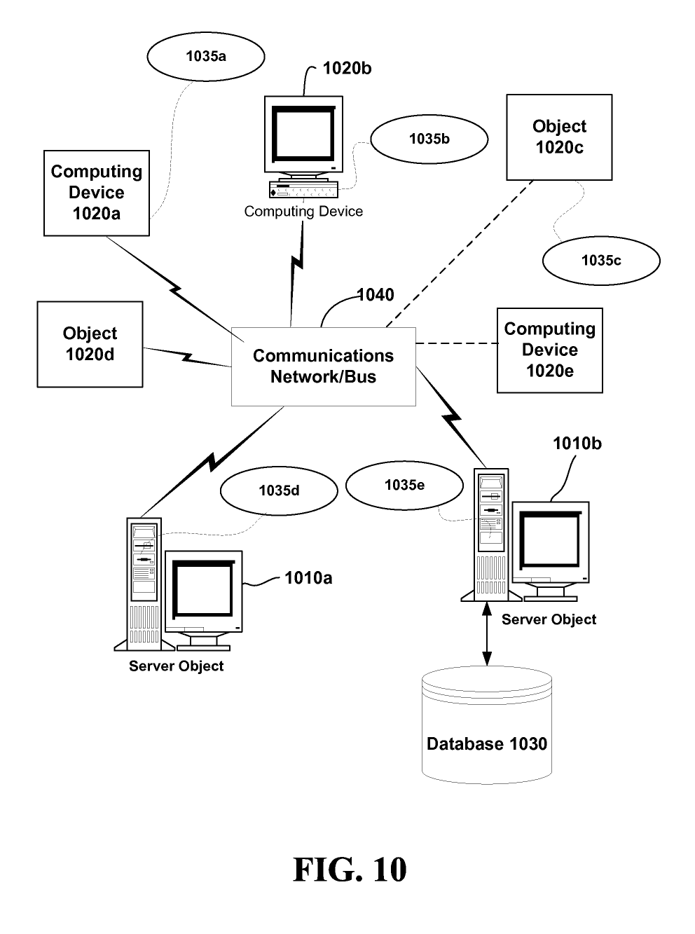

FIG. 10 provides a schematic diagram of an exemplary networked or distributed computing environment. The distributed computing environment comprises computing objects 1010a, 1101b, etc. and computing objects or devices 1020a, 1020b, 1020c, 1020d, 1020e, etc. These objects can comprise programs, methods, data stores, programmable logic, etc. The objects can comprise portions of the same or different devices such as PDAs, audio/video devices, MP3 players, personal computers, etc. Each object can communicate with another object by way of the communications network 1040. This network can itself comprise other computing objects and computing devices that provide services to the system of FIG. 10, and can itself represent multiple interconnected networks. In accordance with an aspect of at least one generalized non-limiting embodiment, each object 1010a, 1010b, etc. or 1020a, 1020b, 1020c, 1020d, 1020e, etc. can contain an application that might make use of an application programming interface (API), or other object, software, firmware and/or hardware, suitable for use with the design framework in accordance with at least one generalized non-limiting embodiment.

It can also be appreciated that an object, such as 1020c, can be hosted on another computing device 1010a, 1010b, etc. or 1020a, 1020b, 1020c, 1020d, 1020e, etc. Thus, although the physical environment depicted can show the connected devices as computers, such illustration is merely exemplary and the physical environment can alternatively be depicted or described comprising various digital devices such as PDAs, televisions, MP3 players, etc., any of which can employ a variety of wired and wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many of the networks are coupled to the Internet, which provides an infrastructure for widely distributed computing and encompasses many different networks. Any of the infrastructures can be used for exemplary communications made incident to optimization algorithms and processes according to the present innovation.

In home networking environments, there are at least four disparate network transport media that can each support a unique protocol, such as Power line, data (both wireless and wired), voice (e.g., telephone) and entertainment media. Most home control devices such as light switches and appliances can use power lines for connectivity. Data Services can enter the home as broadband (e.g., either DSL or Cable modem) and are accessible within the home using either wireless (e.g., HomeRF or 802.11A/B/G) or wired (e.g., Home PNA, Cat 5, Ethernet, even power line) connectivity. Voice traffic can enter the home either as wired (e.g., Cat 3) or wireless (e.g., cell phones) and can be distributed within the home using Cat 3 wiring. Entertainment media, or other graphical data, can enter the home either through satellite or cable and is typically distributed in the home using coaxial cable. IEEE 1394 and DVI are also digital interconnects for clusters of media devices. All of these network environments and others that can emerge, or already have emerged, as protocol standards can be interconnected to form a network, such as an intranet, that can be connected to the outside world by way of a wide area network, such as the Internet. In short, a variety of disparate sources exist for the storage and transmission of data, and consequently, any of the computing devices of the present innovation can share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 10, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices can be processing data or requesting services or tasks that can implicate the optimization algorithms and processes in accordance with at least one generalized non-limiting embodiment.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the optimization algorithms and processes of at least one generalized non-limiting embodiment can be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) can be coupled to one another via TCP/IP connection(s) for high-capacity communication.

Thus, FIG. 10 illustrates an exemplary networked or distributed environment, with server(s) in communication with client computer (s) via a network/bus, in which the present innovation can be employed. In more detail, a number of servers 1010a, 1010b, etc. are interconnected via a communications network/bus 1040, which can be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like in accordance with the present innovation. It is thus contemplated that the present innovation can apply to any computing device in connection with which it is desirable to communicate data over a network.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. can also serve as clients 1020a, 1020b, 1020c, 1020d, 1020e, etc., as can be characteristic of a distributed computing environment.

As mentioned, communications can be wired or wireless, or a combination, where appropriate. Client devices 1020a, 1020b, 1020c, 1020d, 1020e, etc. can or cannot communicate via communications network/bus 14, and can have independent communications associated therewith. For example, in the case of a TV or VCR, there can or cannot be a networked aspect to the control thereof. Each client computer 1020a, 1020b, 1020c, 1020d, 1020e, etc. and server computer 1010a, 1010b, etc. can be equipped with various application program modules or objects 1035a, 1035b, 1035c, etc. and with connections or access to various types of storage elements or objects, across which files or data streams can be stored or to which portion(s) of files or data streams can be downloaded, transmitted or migrated. Any one or more of computers 1010a, 1010b, 1020a, 1020b, 1020c, 1020d, 1020e, etc. can be responsible for the maintenance and updating of a database 1030 or other storage element, such as a database or memory 1030 for storing data processed or saved according to at least one generalized non-limiting embodiment. Thus, the present innovation can be utilized in a computer network environment having client computers 1020a, 1020b, 1020c, 1020d, 1020e, etc. that can access and interact with a computer network/bus 1040 and server computers 1010a, 1010b, etc. that can interact with client computers 1020a, 1020b, 1020c, 1020d, 1020e, etc. and other like devices, and databases 1030.

### Exemplary Computing Device

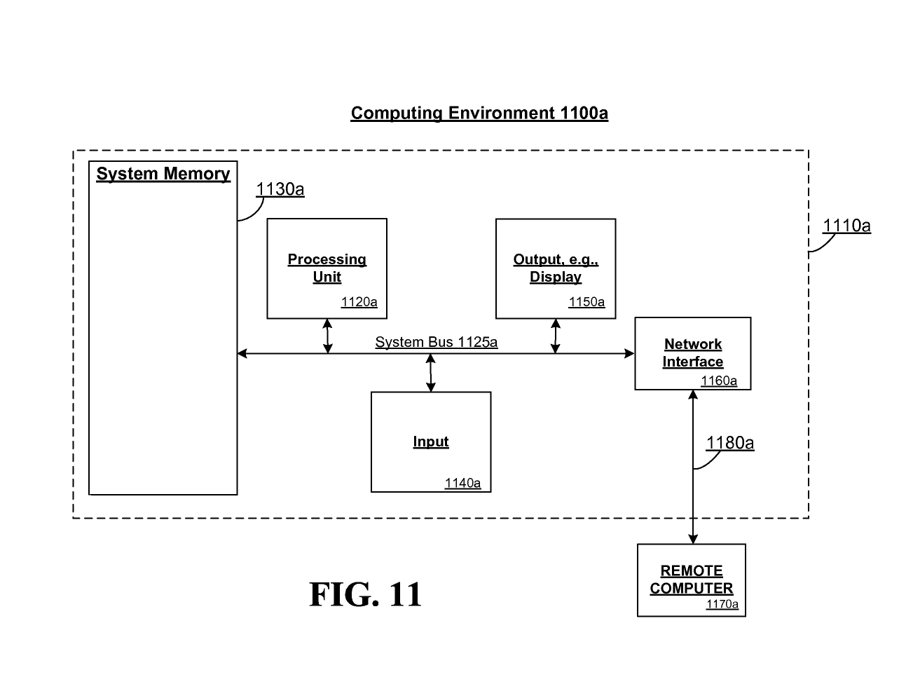

As mentioned, the innovation applies to any device wherein it can be desirable to communicate data, e.g., to a mobile device. It should be understood, therefore, that handheld, portable and other computing devices and computing objects of all kinds are contemplated for use in connection with the present innovation, i.e., anywhere that a device can communicate data or otherwise receive, process or store data. Accordingly, the below general purpose remote computer described below in FIG. 11 is but one example, and the present innovation can be implemented with any client having network/bus interoperability and interaction. Thus, the present innovation can be implemented in an environment of networked hosted services in which very little or minimal client resources are implicated, e.g., a networked environment in which the client device serves merely as an interface to the network/bus, such as an object placed in an appliance.

Although not required, at least one generalized non-limiting embodiment can partly be implemented via an operating system, for use by a developer of services for a device or object, and/or included within application software that operates in connection with the component(s) of at least one generalized non-limiting embodiment. Software can be described in the general context of computer executable instructions, such as program modules, being executed by one or more computers, such as client workstations, servers, or other devices. Those skilled in the art will appreciate that the innovation can be practiced with other computer system configurations and protocols.

FIG. 11 thus illustrates an example of a suitable computing system environment 1100a in which the innovation can be implemented, although as made clear above, the computing system environment 1100a is only one example of a suitable computing environment for a media device and is not intended to suggest any limitation as to the scope of use or functionality of the innovation. Neither should the computing environment 1100a be interpreted as having any dependency or requirement relating to any one or combination of components illustrated in the exemplary operating environment 1100a.

With reference to FIG. 11, an exemplary remote device for implementing at least one generalized non-limiting embodiment includes a general purpose computing device in the form of a computer 1110a. Components of computer 1110a can include, but are not limited to, a processing unit 1120a, a system memory 1130a, and a system bus 1125a that couples various system components including the system memory to the processing unit 1120a. The system bus 1125a can be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media can comprise computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a can include computer storage media in the form of volatile and/or non-volatile memory such as read only memory (ROM) and/or random access memory (RAM). A basic input/output system (BIOS), containing the basic routines that help to transfer information between elements within computer 1110a, such as during start-up, can be stored in memory 1130a. Memory 1130a typically also contains data and/or program modules that are immediately accessible to and/or presently being operated on by processing unit 1120a. By way of example, and not limitation, memory 1130a can also include an operating system, application programs, other program modules, and program data.

The computer 1110a can also include other removable/non-removable, volatile/non-volatile computer storage media. For example, computer 1110a could include a hard disk drive that reads from or writes to non-removable, non-volatile magnetic media, a magnetic disk drive that reads from or writes to a removable, non-volatile magnetic disk, and/or an optical disk drive that reads from or writes to a removable, non-volatile optical disk, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1125a through a non-removable memory interface such as an interface, and a magnetic disk drive or optical disk drive is typically connected to the system bus 1125a by a removable memory interface, such as an interface.

A user can enter commands and information into the computer 1110a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1120a through user input 1140a and associated interface(s) that are coupled to the system bus 1125a, but can be connected by other interface and bus structures, such as a parallel port, game port or a universal serial bus (USB). A graphics subsystem can also be connected to the system bus 1125a. A monitor or other type of display device is also connected to the system bus 1125a via an interface, such as output interface 1150a, which can in turn communicate with video memory. In addition to a monitor, computers can also include other peripheral output devices such as speakers and a printer, which can be connected through output interface 1150a.

The computer 1110a can operate in a networked or distributed environment using logical connections to one or more other remote computers, such as remote computer 1170a, which can in turn have media capabilities different from device 1110a. The remote computer 1170a can be a personal computer, a server, a router, a network PC, a peer device or other common network node, or any other remote media consumption or transmission device, and can include any or all of the elements described above relative to the computer 1110a. The logical connections depicted in FIG. 11 include a network 1180a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1110a is connected to the LAN 1180a through a network interface or adapter. When used in a WAN networking environment, the computer 1110a typically includes a communications component, such as a modem, or other means for establishing communications over the WAN, such as the Internet. A communications component, such as a modem, which can be internal or external, can be connected to the system bus 1125a via the user input interface of input 1140a, or other appropriate mechanism. In a networked environment, program modules depicted relative to the computer 1110a, or portions thereof, can be stored in a remote memory storage device. It will be appreciated that the network connections shown and described are exemplary and other means of establishing a communications link between the computers can be used.

While the present innovation has been described in connection with the preferred embodiments of the various Figures, it is to be understood that other similar embodiments can be used or modifications and additions can be made to the described embodiment for performing the same function of the present innovation without deviating therefrom. For example, one skilled in the art will recognize that the present innovation as described in the present application can apply to any environment, whether wired or wireless, and can be applied to any number of such devices connected via a communications network and interacting across the network. Therefore, the present innovation should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the innovation described herein can have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components can reside within a process and/or thread of execution and a component can be localized on one computer and/or distributed between two or more computers.

Thus, the methods and apparatus of the present innovation, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the innovation. In the case of program code execution on programmable computers, the computing device generally includes a processor, a storage medium readable by the processor (including volatile and non-volatile memory and/or storage elements), at least one input device, and at least one output device.

Furthermore, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

In view of the exemplary systems described supra, methodologies that can be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks can be required to implement the methodologies described hereinafter.

Furthermore, as will be appreciated various portions of the disclosed systems above and methods below can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present innovation has been described in connection with the preferred embodiments of the various figures, it is to be understood that other similar embodiments can be used or modifications and additions can be made to the described embodiment for performing the same function of the present innovation without deviating therefrom.

While exemplary embodiments refer to utilizing the present innovation in the context of particular programming language constructs, specifications or standards, the innovation is not so limited, but rather can be implemented in any language to perform the optimization algorithms and processes. Still further, the present innovation can be implemented in or across a plurality of processing chips or devices, and storage can similarly be effected across a plurality of devices. Therefore, the present innovation should not be limited to any single embodiment, but rather should be construed in breadth and scope in accordance with the appended claims.

What is claimed is:

1. A method of fabricating an antenna, the method comprising:
etching a central portion of a silicon substrate to form two independent antenna halves;
applying a photoresist material to the etched central area; and
treating the photoresist material to harden the photoresist material.

2. The method of claim 1, wherein the treating includes exposing the photoresist material to ultraviolet (UV) energy.

3. The method of claim 1, wherein treating the photoresist material comprises baking the photoresist material.

4. The method of claim 1, wherein the etching includes etching the central portion such that the antenna halves resonate at about 5.8 GHz.

5. The method of claim 1, wherein etching includes etching the central portion such that the antenna halves and photoresist material form an antenna approximately 12 mm in length.

6. The method of claim 5, wherein the etching includes etching the central portion such that the antenna halves and photoresist material form an antenna approximately 2.8 mm in width.

7. The method of claim 6, wherein the etching includes etching the central portion such that the antenna halves and photoresist material form an antenna approximately 400 um in thickness.

8. The method of claim 1, wherein the etching a central portion of a silicon substrate to form two independent antenna halves comprises etching a central portion of a silicon substrate to form two independent antenna halves shaped at first triangular and then rectangular in elongated pentagons.

9. The method of claim 1, wherein the etching a central portion of a silicon substrate to form two independent antenna halves comprises etching a central portion of a silicon substrate to form two independent antenna halves shaped at first triangular and then rectangular in elongated pentagons with at least one slit in the rectangular area.

10. The method of claim 1 further comprising positioning a differential feed in the central portion.

11. An antenna comprising:
a first half-antenna portion;
a second half-antenna portion separated from the first half-antenna portion; and
a photoresist material connecting the first and second half-antenna portions.

12. The antenna of claim 11, wherein the antenna resonates at about 5.8 GHz.

13. The antenna of claim 11, wherein the first and second half-antenna portions both include at least one slit.

14. The antenna of claim 11 further comprising a differential feed operationally coupled to the first and second half-antenna portions.

15. The antenna of claim 11, further comprising a silicon nitride layer operationally coupled to the first and second half-antenna portions.

16. The antenna of claim 11, wherein the first and second half-antenna portions shaped at first triangular and then rectangular in elongated pentagons.

17. The antenna of claim 11, wherein the antenna has a gain of about −2.19 dB.

18. The antenna of claim 10, wherein the antenna has an efficiency of greater than approximately 20%.

19. Antenna apparatus comprising.
first means for radiating a RF field;
second means for radiating a RF field; and
means for supporting the first and second means wherein the radiation efficiency is greater than approximately 20%.

20. Apparatus according to claim 19 wherein the means for supporting includes a photoresist material.
